(19) United States
(12) Patent Application Publication
(10) Pub. No.: US 2014/0366844 A1
(43) Pub. Date: Dec. 18, 2014

(54) INJECTOR SYSTEM, IN PARTICULAR INJECTOR BLOCK FOR FUEL INJECTION SYSTEMS

(71) Applicants: Wolf Stahr, Abstatt (DE); Martin Haug, Weil Der Stadt (DE); Horst Kirschner, Brackenheim-Hausen (DE); Frank Miller, Ilsfeld (DE)

(72) Inventors: Wolf Stahr, Abstatt (DE); Martin Haug, Weil Der Stadt (DE); Horst Kirschner, Brackenheim-Hausen (DE); Frank Miller, Ilsfeld (DE)

(21) Appl. No.: 13/996,198

(22) PCT Filed: Nov. 4, 2011
(86) PCT No.: PCT/EP2011/069429

§ 371 Date: Aug. 15, 2014

(30) Foreign Application Priority Data
Dec. 23, 2010 (DE) 102010064137.5

(51) Int. Cl. F02M 41/00

(52) U.S. Cl. CPC F02M 41/00
USPC 123/456

(57) ABSTRACT

An injector system used as an injector block for fuel injection systems of mixture-compressing, spark-ignited internal combustion engines includes: a first block element which has a fuel distribution channel, and at least one second block element on which a first connecting piece and at least one second connecting piece are situated. Injectors are positioned within the first and second block elements in such a way that the first injector is assigned to the first connecting piece and the second injector is assigned to the second connecting piece. The fuel distribution channel of the first block element is used for distributing compressed natural gas to the injectors.

### BACKGROUND OF THE INVENTION

1. Field of the Invention

The present invention relates to an injector system which is in particular suitable for mixture-compressing, spark-ignited internal combustion engines.

2. Description of the Related Art

A mixture-compressing, spark-ignited internal combustion engine may be suitable for an operation using gasoline and natural gas. To provide original equipment for or to retrofit a gasoline-operated internal combustion engine, a vehicle-specific adaptation is, however, necessary, since corresponding openings are, for example, required on the intake module for the installation of the injectors, and fastening points are required for fastening the injector system in the engine compartment. In the case of retrofittings, the quality, which is demanded by the manufacturers in emerging countries, in particular, is not achieved.

### BRIEF SUMMARY OF THE INVENTION

The injector system according to the present invention has the advantage that an improved design, in particular a compact and robust design, is made possible. In particular, a high quality injector system having a wide range of applications may be produced.

It is advantageous that the fuel distribution channel of the first block element is used for distributing natural gas to the injectors. The natural gas is in this case preferably stored as compressed natural gas in a gas storage, e.g., at pressures of approximately 20 MPa (200 bar). Such a compressed natural gas is also referred to as CNG. The term natural gas is, however, not limited to natural gas, per se, but is to be understood in general. For example, the natural gas may also be obtained artificially by coal gasification. Thus, the term natural gas is also understood to mean fuels which are similar to natural gas. The gas storage in which the natural gas is stored may, for example, be connected to the first block element via solid piping.

It is advantageous that the first block element has an internal front side, that the second block element has an internal front side, that the internal front side of the first block element faces the internal front side of the second block element, and that the front side of the first block element rests against the front side of the second block element at least indirectly. Here, it is furthermore advantageous that a seal is situated between the front side of the first block element and the front side of the second block element and that the front side of the first block element rests against the front side of the second block element via the seal. The joined block elements may surround the injectors at least essentially. Therefore, a compact construction is ensured, a reliable fixing of the injectors and protection against mechanical damage being additionally implemented. Moreover, suitable fastening points may be selected largely arbitrarily on the block elements to fasten the injector system in an engine compartment, for example. The seal between the block elements may be designed as an elastic seal and enable a certain oscillation damping. Due to the compact and largely closed off design of the injector system, protection of the injectors against contamination is furthermore achieved.

It is also advantageous that centering elements are provided which center the block elements relative to one another. In this case, it is also advantageous that the centering elements each sectionally engage with the first block element on the front side of the first block element and each sectionally engage with the second block element on the front side of the second block element. With the aid of the centering elements, which may in particular be designed as centering pins, the mechanical stability of the injector system is improved in addition to a positioning of the block elements relative to one another. In particular, the positioning of the injectors within the block elements is reliably ensured.

It is also advantageous that the block elements are connected to one another via connecting means. Screws, in particular, are suitable as connecting means. Connecting bars or the like are not necessary for connecting the block elements. In this way, the number of the required components may be reduced. In addition, a robust design is made possible. Furthermore, spacing pieces or the like may also be omitted, since there is no space between the block elements in the first place and thus it is not necessary to bridge a space.

In addition, it is advantageous that the injectors are each inserted into the second block element via an elastic sealing ring. In this way, a damping may be achieved so that shocks transferred to the second block element do not affect the injectors and their function.

Moreover, it is advantageous that the connecting pieces each have a hose nipple on their output sides. The connection to an intake manifold may, for example, take place via hoses, whereby a high flexibility is ensured which enables a wide range of applications. In particular, the injector system may be used for a plurality of differently designed internal combustion engines.

In addition, it is advantageous that a recess, via which an electrical contacting of the injectors is enabled, is provided on the assembled block elements. For example, electrical plugs of the injectors may be conducted to the outside through the recess. In the area of the recess, mechanical protection of such plugs is then additionally ensured.

### BRIEF DESCRIPTION OF THE DRAWINGS

FIG. 1 shows a schematic illustration of an injector system according to one exemplary embodiment of the present invention.

FIG. 2 shows a schematic illustration of the injector system shown in FIG. 1 from the viewing direction denoted with reference numeral II.

### DETAILED DESCRIPTION OF THE INVENTION

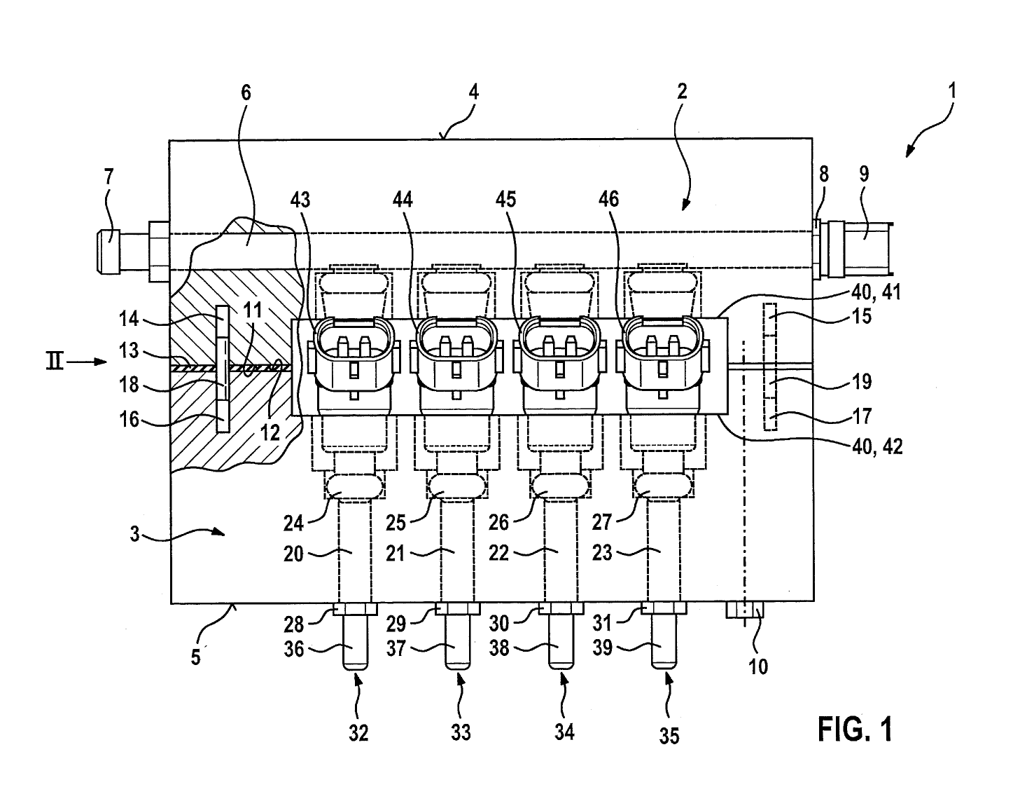

FIG. 1 shows an injector system 1 in a schematic illustration according to one exemplary embodiment of the present invention. Injector system 1 may, in particular, be designed as an injector block 1. Here, injector system 1 is, in particular, suitable for fuel injection systems of mixture-compressing, spark-ignited internal combustion engines. In this case, injector system 1 is preferably used for compressed natural gas.

Injector system 1 has a first block element 2 and a second block element 3. First block element 2 has a side (top side) 4. Second block element 3 has a side (bottom side) 5. Top side 4 of first block element 2 represents top side 4 of injector system 1. Furthermore, bottom side 5 of second block element 3 represents bottom side 5 of injector system 1. First block element 2 has a fuel distribution channel 6 which is implemented within first block element 2. Here, on first block element 2, a connecting piece 7 is installed via which the compressed natural gas is conducted into fuel distribution channel 6. For this purpose, connecting piece 7 is suitably connected to a fuel tank, in particular a gas tank. Moreover, a sensor 8 having a plug 9 is installed on first block element 2. Sensor 8 is, for example, used for measuring the pressure and the temperature of the fuel provided in fuel distribution channel 6. A connection of sensor 8 to a control unit is enabled via plug 9.

Block elements 2, 3 are connected to one another via one or multiple connecting means 10. A screw may, for example, be used as connecting means 10. First block element 2 has a front side 11.

Second block element 3 has a front side 12. A seal 13 is situated between front side 11 of first block element 2 and front side 12 of second block element 3. Seal 13 is designed as an elastic seal 13 in this case, and made of an elastomer, for example. Here, seal 13 also ensures a certain damping between block elements 2, 3. In particular, an oscillation transmission is prevented.

First block element 2 has bore holes 14, 15 which extend perpendicularly into first block element 2 starting from front side 11. Furthermore, second block element 3 has bore holes 16, 17 which extend perpendicularly into second block element 3 starting from front side 12. A centering element 18 is situated in bore holes 14, 16 of block elements 2, 3. A centering element 19 is furthermore situated in bore holes 15, 17 of block elements 2, 3. In this exemplary embodiment, centering elements 18, 19 are implemented as centering pins 18, 19. For this purpose, centering pins 18, 19 each sectionally engage with first block element 2 on front side 11 of first block element 2. In addition, centering pins 18, 19 each sectionally engage with second block element 3 on front side 12 of second block element 3. Thereby, block elements 2, 3 are positioned relative to one another and are also reliably connected to one another in the installed state in conjunction with connecting means 10. In particular, a compact design and great mechanical stability of assembled block elements 2, 3 are achieved.

Injectors 20, 21, 22, 23 are provided within block elements 2, 3. Other injectors 22, 23 are provided here in addition to first injector 20 and second injector 21. The number of injectors 20 through 23 is predefined with regard to the particular application. The number of the injectors is not limited here to the two injectors 20, 21 and may be greater than 2, in particular greater than 4.

Injectors 20 through 23 are inserted into second block element 3 via elastic sealing rings 24, 25, 26, 27. This ensures an oscillation damping between injectors 20 through 23 and second block element 3. In particular, it is avoided that shocks of second block element 3 have a negative effect on the functionality of injectors 20 through 23.

In the area of bottom side 5, connecting pieces 28, 29, 30, 31 are screwed into second block element 3. Connecting pieces 28 through 31 each have a hose nipple 36, 37, 38, 39 on their respective output sides 32 through 35. Hoses or the like may be connected to hose nipples 36 through 39 to connect connecting pieces 28 through 31 to intake manifolds of an internal combustion engine, for example. The particular quantity of the supplied, compressed natural gas is controllable via injectors 20 through 23, in this case.

A recess 40 is provided on assembled block elements 2, 3. In this exemplary embodiment, recess 40 is designed as a window-shaped recess 40. In this exemplary embodiment, a first part 41 of recess 40 is situated on first block element 2. A second part 42 of recess 40 is situated on second block element 3. It is also possible that recess 40 is situated completely on, in particular within, first block element 2, or on, in particular within, second block element 3. Electrical connections 43, 44, 45, 46 of injectors 20 through 23 are accessible from the outside via recess 40. In this exemplary embodiment, electrical connections 43 through 46 protrude outward through recess 40.

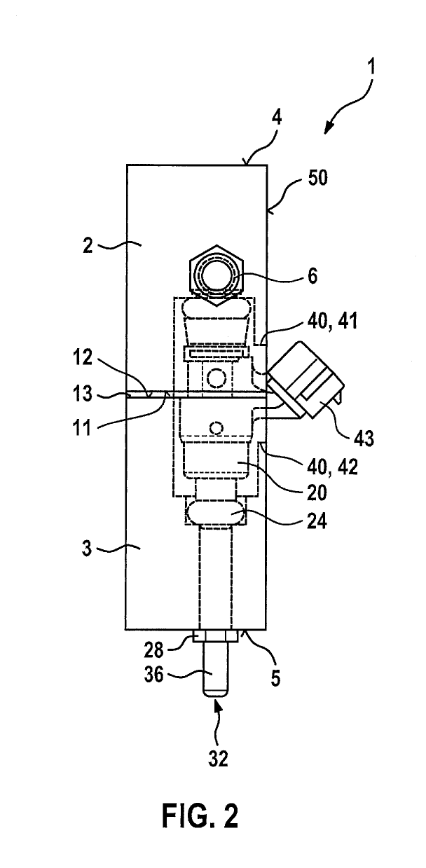

FIG. 2. shows injector system 1 illustrated in FIG. 1 in a schematic illustration from the viewing direction denoted with reference numeral II. Assembled block elements 2, 3 have a common side (front side) 50. Injector 20 is positioned between fuel distribution channel 6 and connecting piece 28. Accordingly, the other injectors 21 through 23 are also positioned between fuel distribution channel 6 and their respective connecting pieces 29 through 31. Electrical connection 43 of injector 20 protrudes through recess 40 partially beyond front side 50. Electrical connection 43 of injector 20 is thus partially in front of front side 50 so that a suitable plug may be installed on electrical connection 43 of injector 20. Accordingly, electrical connections 44 through 46 of injectors 21 through 23 partially protrude beyond front side 50 so that they, too, may be contacted using suitable plugs. In this way, a connection of injectors 20 through 23 to the control unit is enabled.

1-10. (canceled)

11. An injector system for a mixture-compressing, spark-ignited internal combustion engine, comprising:
a first block element which has a fuel distribution channel;
at least one second block element on which a first connecting piece and at least one second connecting piece are situated;
a first injector; and
at least one second injector;
wherein the first injector and the second injector are positioned within the first block element and the second block element in such a way that the first injector is assigned to the first connecting piece and the second injector is assigned to the second connecting piece, and the fuel distribution channel of the first block element distributes fuel to the first injector and the second injector.

12. The injector system as recited in claim 11, wherein the fuel distribution channel of the first block element distributes natural gas to the first and second injectors.

13. The injector system as recited in claim 11, wherein:
the first block element has an internal front side;
the second block element has an internal front side;
the internal front side of the first block element faces the internal front side of the second block element; and
the front side of the first block element at least indirectly rests against the front side of the second block element.

14. The injector system as recited in claim 13, wherein a seal is situated between the front side of the first block element and the front side of the second block element, and the front side of the first block element rests against the front side of the second block element via the seal.

15. The injector system as recited in claim 13, wherein a first centering element and at least one second centering element are provided which center the first and second block elements relative to one another.

16. The injector system as recited in claim 15, wherein the first and second centering elements (i) each sectionally engage with the first block element on the front side of the first block element, and (ii) each sectionally engage with the second block element on the front side of the second block element.

17. The injector system as recited in claim 13, wherein the first and second block elements are connected to one another via at least one connecting element.

18. The injector system as recited in claim 13, wherein the first and second injectors are each inserted into the second block element via at least one elastic sealing ring.

19. The injector system as recited in claim 13, wherein a hose nipple is provided on an output side of each of the first and second connecting pieces.

20. The injector system as recited in claim 13, wherein at least one recess, via which an electrical contacting of the first and second injectors is implemented, is provided on the first and second block elements.
